(19) United States
(12) Patent Application Publication
(10) Pub. No.: US 2012/0223094 A1
(43) Pub. Date: Sep. 6, 2012

(54) INTELLIGENT MONITORING AND CONTROL SYSTEM FOR DISPENSED CHILLED FOOD PRODUCT DEVICES

(75) Inventors: Carl Tex Rickard, JR., Las Vegas, NV (US); Carl Tex Rickard, III, Henderson, NV (US); Justin G. Downs, III, Las Vegas, NV (US)

(73) Assignee: SOFT SERVE PARTS LLC, Las Vegas, NV (US)

(21) Appl. No.: 13/040,054

(22) Filed: Mar. 3, 2011

(51) Int. Cl. B67D 7/22; B67D 7/24

(52) U.S. Cl. 222/1; 222/30

(57) ABSTRACT

A dispensing chills viscous edible composition. The dispensing system may have:
a storage container for the viscous edible composition;
a composition moving system;
a composition chilling system;
a cooling system;
an electromechanical system control components;
an electrical input system for providing power to the components of the system;
an electrical communication network among the electrical input system and the components of the system;
a sensor for detecting at least one performance attribute that occurs during a) movement of the composition by the composition moving system; b) during chilling of the composition by the chilling system; c) during cooling of the system by the cooling system; or d) during control of the system by the control system;
the sensors providing signals to electronic hardware;
the electronic hardware registering sensor signals with a time stamp;
the electronic hardware configured to perform data analysis on the time-stamped signals derive to detecting and recording specified undesirable performance of the dispensing system.

### BACKGROUND OF THE INVENTION

1. Field of the Invention

The present invention relates to the field of blending and/or dispensing systems for chilled, viscous, food products such as soft ice cream, custard, gelati, custard and the like. An intelligent monitoring system includes sensing devices capable of monitoring operational parameters of electro-mechanical components of the chilled food product device, including but not limited to motor current sensing, voltage sensing, volume sensing, flow sensing, temperature sensing, times of operation for components, state of switches, etc. Moreover, intelligent systems can identify, by using analysis algorithms on preferably time stamped data acquired from the sensors, either deficiencies or defects in the apparatus, altered states in the performance of the apparatus or components of the apparatus (short of catastrophic failure, or gross failure in performance that I visually observable) that indicates a need for repair or servicing. Intelligent systems can derive time dependent data using analysis algorithms relating to time of use, volume of product dispensed, etc. Intelligent systems can also actively control subsystems within the machine if needed. Finally, intelligent systems can present such data in a useful, easily understood fashion to an end user.

2. Background of the Art

There are many different types of preparation and/or dispensing devices for chilled, viscous edible materials. These devices tend to move volumes of materials at relatively slow speeds so that variations in performance are difficult to detect by visual observation alone. Small variations in performance can be indicative of numerous undesirable deficiencies in components, efficiency or maintenance of the device. Often, the small variations may be indicative of the need for specific maintenance or parts replacement. These small variations are not necessarily easily observed by the user, so prediction of failure in the systems is difficult.

Current devices also offer little benefit to the end user in the form of direct feedback on operational parameters such as time in use, individual components time of use, material volume dispensed, or critical food service parameters such as time since it was last cleaned, filled, product was drawn, storage temperatures, etc. Current device technology offers none of these monitoring capabilities either locally or remotely. It is left to the device operator to devise a method for monitoring the aforesaid parameters and derive important time sensitive conclusions. Current devices also offer no time-history of operational parameters for the end user.

Among the various types of apparatus useful for the blending and/or dispensing of viscous materials include Published U.S. Application Document Nos. 20100116846; 20100122539; 20100075013; 20080140437; and 20090016150; and U.S. Pat. Nos. 6,907,743; 6,637,214; 6,145,701; 5,743,639; 4,732,013 (Freezer with helical scraper blade); 4,580,905 (Flavor mixing and dispensing device for frozen confection machines); 4,544,085 (Pump type dispenser for heat softenable food products); 4,479,423 (Continuous-flow type apparatus for pasteurizing batches of product); and 4,461,405 (Apparatus for dispensing dry powdered material). These cited references are incorporated herein by reference in their entirety.

It would be desirable to be able to detect efficiencies in performance which are indicative of need for maintenance such as even cleaning so as to alert users of the system that repairs are desirable or needed. Additionally it would be desirable to enable monitoring of product disbursement parameters such as volumes, temperatures, flow rates, time in use, peak usage periods, alarm generation on errors, time to clean, refill, etc. Finally, it would be useful to present this data to an end user such as an owner and/or maintenance personnel in a utilitarian, easily understandable fashion.

### SUMMARY OF THE INVENTION

A sensing system reads one or more parameters of performance in a blending/dispensing system. The sensing system feeds sensed performance information to hardware (e.g., a processor or program specific hardware, e.g., field programmable gated array or ASIC) to identify variations in that specific performance characteristic that identifies a servicing need in the blending/dispensing system. Upon identification of a level r variation in that specific performance characteristic, early servicing can be effected.

The sensing system may be built into an original blending/dispensing system or retrofit into an existing blending/dispensing system. By selection of specific characteristics of performance unique to individual systems or generic to all blending/dispensing systems, the sensing system and the hardware indicate the need or even degree of need for servicing.

### BRIEF DESCRIPTION OF THE FIGURES

FIG. 1 shows a schematic drawing of a blending/dispensing system to which a sensing system may be attached therein.

FIG. 2 shows a flow diagram of a processing system according to the present invention.

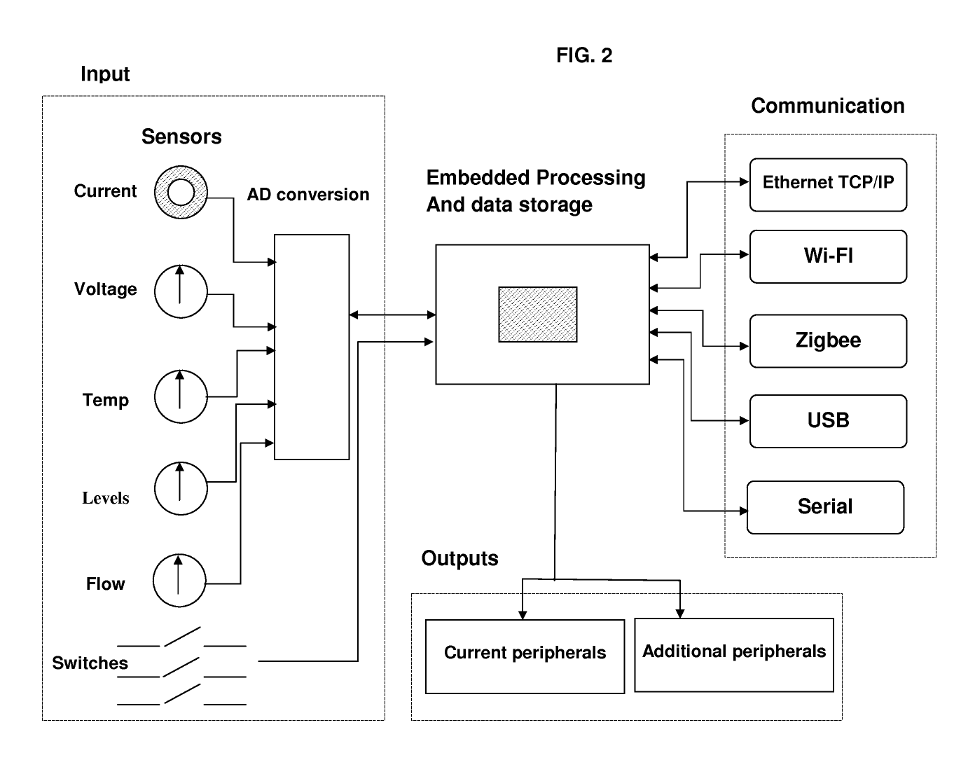

### DETAILED DESCRIPTION OF THE INVENTION

### Description of Current Soft Ice Cream Machines:

Soft ice cream machines (and their derivatives such as “Slurpy”™ beverage and shake machines) come in a large number of different configurations. The operating principals for all are similar. First, define several terms and concepts:
Material cooling—in referring to the edible material, it means to reducing its temperature to a point for safe food handling such as your refrigerator (approx. 35° F.)
System cooling—in referring to the machine, it means eliminating the waste heat generated during operation of the device
chilling—in referring to the edible material, it means reducing its temperature well below freezing to produce a semi-solid (while beating the solid to prevent complete solidification)
Work—work performed in the physics or engineering sense as measured by Joules, etc.
electrical—refers to higher voltage, AC circuitry often performing Work such as motors or devices enabling the performance of work such as contactors
electronics—refers to lower voltage DC circuitry not performing Work but controlling the electrical Work via relays and/or solid state circuitry and sensing the current state of subsystems within the system
IC—Integrated Circuit
logic signal—low voltage DC signal found in IC electronics, usually 5-15V, depending on the IC technology
ADC—Analog to Digital Convertor

### Theory of Operation

Some forms of edible, liquid material are chilled and held in a hopper for batch or continuous dispensing. The material to be chilled is cooled by some form of cooling means, while sitting in the hopper, to an intermediate temperature meeting safe food handling guidelines (it is not necessarily cooled to freezing temperatures at this time). There is a method for the material to be moved from the hopper into a chiller and mixer device (usually this is gravity, although it may be powered by screws, pumps, pressure differentials and the like). When the material moves to the mixing device, a second cooling means often chills the material to a lower or even freezing temperatures while a mixing device, called a beater, stirs the mix (in the most basic configuration, the same cooling means and some crossover valving are used to accomplish cooling at two different temperatures). All of this Work generates a lot of waste heat and so there is some form of systemic cooling for the machine itself. This can be as simple as convective flow but is usually done with airflow using fans and/or water flow over a heat exchanger.

The Work of cooling, chilling and mixing is performed by electric motors. The electric motors are typically controlled by simple processing electronics hardware using a series of interfaces that transform the low voltage logic signals of the processing electronics into control of higher AC voltages for the motors. This transfer is accomplished via DC relays and AC electrical contacts.

To determine when to operate the various components of the device, the system is outfitted with several sensors to determine temperature of the material in the hopper, temperature of the material in the mixer and usually the amount of Work being performed by the mixer (by partially measuring current flow to the motor performing beater Work). The output of these sensors is a voltage level that is a transformation (e.g., linear or scholastic) of the temperature in degrees into a voltage level or current draw in amps into a voltage level. The output of these sensors is inputted to the electronics processing hardware.

The electronics processing hardware in more modern systems is microprocessor based. The sensor output is converted in an ADC into a binary representation of the measured voltage. Desired temperature and amperage set-points are generated by a variable voltage circuit that is user adjustable. The set-point voltages are also converted by an ADC into a binary representation of the setpoint voltage. The microprocessor then ‘compares’ the two binary representations and decides when to turn the various Work components on.

In older systems the processing hardware is as simple as discreet electronic components (using a comparator IC) comparing the two voltages from the sensor and the set-point voltage generator and outputting a logic level signal for control of the Work components.

### The Most Basic Configuration of the Present Invention Technology

In a most basic configuration, the machine will comprise:
1. mechanical frame that holds the various components
2. a container (hopper) for holding the edible material
3. a way to cool the hopper
   a. using a basic refrigeration device composed of:
      i. motor to perform Work
      ii. compressor
      iii. condenser
      iv. evaporator
      v. expansion valve
4. a beating device for the material
5. a way to chill the beating device (NOTE: the chiller is usually a cooling device capable of cooling to lower temperatures than the hopper cooler)
   a. using a basic refrigeration device composed of:
      i. motor to perform Work
      ii. compressor
      iii. condenser
      iv. evaporator
      v. expansion valve
6. a way to cool the motors used for cooling and chilling
   a. may, by way of non-limiting examples, be fan powered by a motor to perform Work
7. electrical circuitry for providing electricity to the motors as single phase 240 VAC
8. electronics circuitry to control the electrical circuitry
9. electronics circuitry to provide a user interface for operation of the device

### Options to the Basic Configuration

The devices take many forms.

The first aspect to be described is as an alternate device that may or may not be available as an option to the basic form, but may be separately provided as a distinct system or as an add-on to more advanced systems. In that case, the cooling and chilling is performed by a single refrigeration apparatus and solenoid controlled valving is used to switch between the two refrigeration needs. In this case, the basic configuration is the same as above without the second refrigeration section but adding some solenoid controlled valving components.

### Other Options:

1. water flow to cool the components controlled by a solenoid valve
2. operation on 3 phase VAC
3. multiple hoppers
4. multiple beaters
5. multiple refrigeration circuits
6. multiple controls

### Additional Definitions Used for the Invention:

CT—current transformer—a type of transformer that induces a current in a secondary coil when a current flows in a primary coil
VT—voltage transformer—a type of transformer that changes a high voltage level on a primary coil to a lower voltage level on a secondary coil. Used to measure high voltages beyond the range of ADC electronic circuitry.
RMS—Root Mean Square—a measure of AC power carrying potential. 240 VAC is over 360V peak-to-peak voltage making power calculations more difficult since power is related to the integral of voltage, not peak value.
IO—Input/Output—a standard term in microprocessor monitoring systems indicating direct connection with a processor. It can be a single line or a group of lines as a bus.
HTML—HyperText Markup Language—the standard language all web browser use
HTTP—HyperText Transfer Protocol—the method by which HTML is transferred
CGI—Common Gateway Inteface—a standard for communication between HTTP servers and other programs so a program running on a processor can generate the HTML code necessary to interact with a remote browser rather than serving static web pages. This allows the user to interact with the device in a real time fashion such as reading operation parameters.
Thin Client Term referring to a computer that depends on another computer to run software rather than running the software itself. For an embedded web server, it serves web pages of information that other computers can access without any specialized software running on the remote computer other than a standard web browser. This differs from classic system monitoring approaches that often need specialized software installed on every computer that may interact with the embedded web server.

The presently disclosed technology and invention relates to a monitoring and control system tailored to the needs of personnel whose modes of interaction with frozen edible cooling and delivering system, such as an ice cream machine. The systems are to be owned, leased, operated, maintained and/or sold as part of an addition to the known background technology of the frozen edibles machines previously described. The needs for each mode of interaction with the device vary. For instance, an owner may want to know time in use, amount dispensed, material levels, power consumption, etc. A lessee/lessor on a time based contract would also want to know time in use. The machine operator may want to know if the machine requires cleaning, maintenance, addition of product, etc. Maintenance personal may wish to know operational parameters that may assist them in troubleshooting and maintaining the device (same for a lessor). Finally sales personnel may want to offer such a monitoring system as a significant advantage over competitors similar machines without monitoring capability.

One aspect of the present invention is to provide greater ease of use to all users by providing in-depth information concerning operational parameters and statistics using both current and historic data from at least individual dispensing systems. Additionally, derived information will be provided that uses current and historical data to reach some conclusion concerning the operation and state of the machine. Such derivation may be accomplished in a number of different ways as simple as table look-up or as complex as neural-net processing for separation of linearly independent operating parameters indicating state, error or other operational conditions of interest.

While in the practice of the present invention new machines may be constructed with this ability, current machines in use and/or machines being refurbished for reuse may have such a system installed as a retrofit kit. This enables even older machines to offer state-of-the-art monitoring and control for a fraction of the cost of purchasing a new machine.

The operational parameters and statistical information in both current and historical format will be provided to the end user in several ways. One way may be via direct interaction with the system using a device such as an LCD touch screen that the user may interact with, receiving information by direct readout and/or controlling the machine directly. More commonly, it is expected that user interaction will be using a web browser. For instance, if an end user connects to a machine via Ethernet (or Zigbee or USB, etc) and requests information that may be current, historic or derived, the system will provide CGI generated web pages providing that information. CGI generation also allows feedback control of the device from a remote location In this fashion, an end user can interact with the machine whether located locally or remotely.

The monitoring system, when appropriate communications such as Ethernet is enabled, will be capable of communication with a remote server to download current, historic and derived data to the remote server for archiving. In this instance, an end user may use the remote server to request the current, historic and/or derived data indirectly without need to connect directly to the machine. The remote server generates web pages in the same CGI fashion as the device itself for consumption by the end user. Standard commercially available hardware (PC or MAC system, as well as proprietary LINUX and private systems may also be used, along with commercial and/or proprietary software). Hardwired or WiFi transmission of information, or direct downloading of the information into storage devices (floppies, CDs, DVDs, USB memory sticks and newer technologies) may also be used.

Additionally, the monitoring system may be capable of operating peripheral components of the machine directly whether they are original components or additional components added during retrofit and/or refurbishment. For instance, in a lessee/lessor arrangement, the lessor may wish to inhibit operation of the machine in the event of non-payment. The control capability may extend to replacing the original controller of a refurbished machine completely. Additional peripherals could include, by way of non-limiting examples:

1. Watchdog cutoff—resettable logic that discontinues operation of the machine in the event a operational code is not entered in a periodic fashion.

2. Flow meter to determine specific amount of product dispensed such as mounting one on the hopper exit.

3. Electronically controlled expansion valve in the chilling system to regulate the chilled product temperature enabling energy savings while in standby mode.

4. Secondary cooling system integrated with the chilling system to allow energy savings while in standby mode.

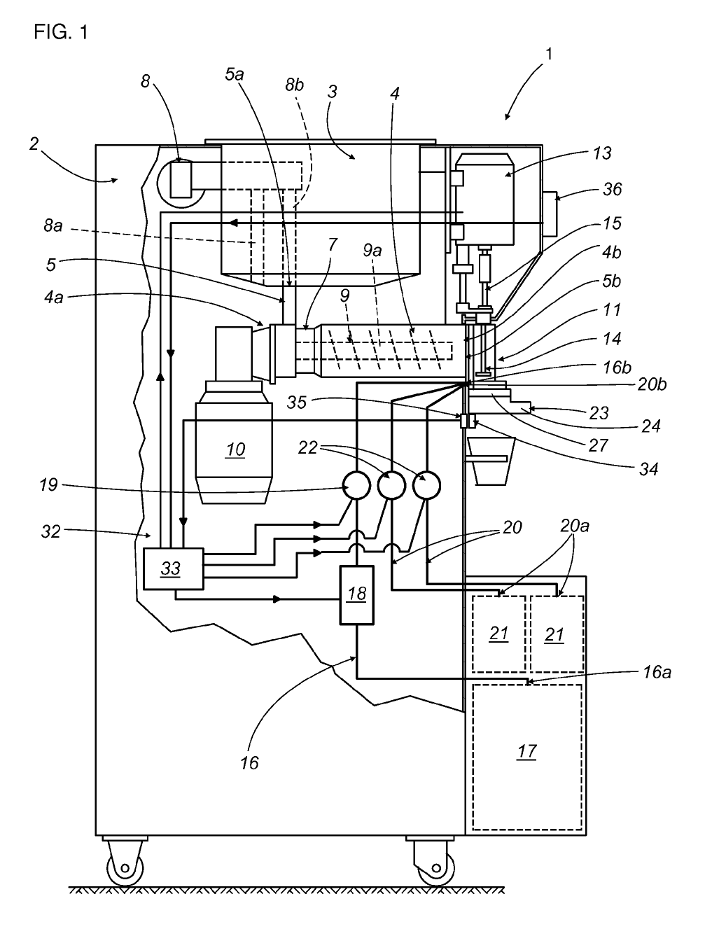

FIG. 1 shows a cutaway view of an apparatus to which the sensing technology and systems of the present invention may be attached. The sensor and wired or non-wired communication system is appropriately and positionally affixed to sense the specific data, signal, parameter desired for that particular sensor.

In particular, as illustrated in FIG. 1, the main processing circuit 5 has a freezing chamber 4, and a refrigerating unit 7 schematically illustrated and consisting of a motor-driven compressor, a condenser and an evaporator (of the known type and therefore not described and illustrated in detail) connected to the freezing chamber 4.

The freezing chamber 4 and the mixing chamber 6 together form a processing chamber 37.

The freezing chamber 4 has a substantially cylindrical shape and forms a rear end 4a connected to the tank 3 and a front end 4b forming the above-mentioned outfeed end 5b of the main processing circuit 5.

The product to be processed is fed by a gear pump 8, positioned at the tank 3 and in communication with the latter with an intake pipe 8a for drawing the product from the tank 3 and sending it through a delivery pipe 8b to the rear end 4a of the freezing chamber 4.

Extending inside the freezing chamber 4 there may be a stirrer 9 designed to feed forward the product to be processed from the rear end 4a to the front end 4b. The stirrer 9 consists of a screw feeder 9a driven to rotate about its own axis by respective movement means 10 such as a gear motor unit and able to push the product towards and into a dispenser tap 11 mounted on the front end 4b of the freezing chamber 4.

In particular, the dispenser tap 11 projects outside the frame 2 from a front wall of the frame 2 and inside forms the mixing chamber 6. The tap 11 also comprises an outfeed pipe 12 through which the ice cream or ice cream shake fed into the mixing chamber 6 is made to come out by suitable dispensing means 13 of the known type and therefore not described and illustrated in detail.

The dispensing means 13 may comprise a mixing element 14 rotatably inserted in the mixing chamber 6 to mix the product to be processed inserted in the chamber 6 as described in more detail below. The dispensing means 13 also may comprise an actuator 15 able to move in the mixing chamber 6 to open and close holes for delivery of the ice cream or ice cream shake towards the outfeed pipe 12.

The actuator 15 is preferably a piston operated electronically or manually using suitable levers, which can be inserted in the mixing chamber 6.

The machine 1 in FIG. 1 also may comprise an auxiliary processing circuit 16 extending inside the box-shaped frame 2 and having an infeed end 16a connected to a tank 17 for containing a diluting liquid, and an outfeed end 16b connected to the mixing chamber 6. In particular, the auxiliary processing circuit 16 is designed to supply to the mixing chamber 6 a diluting liquid such as water or milk, for making the ice cream shake. The auxiliary processing circuit 16 may have a heating element 18 interposed between the tank 17 and the outfeed end 16b which is designed to heat the liquid supplied to the mixing chamber 6.

Advantageously, the tank 17 may be equipped with respective heating or cooling means not illustrated in the accompanying drawings and set up to keep the diluting liquid at a predetermined temperature. The auxiliary processing circuit 16 also comprises a pump 19 interposed between the heating element 18 and the outfeed end 16b, for feeding the liquid from the tank 17 to the mixing chamber 6. Advantageously, the machine 1 also comprises at least one circuit 20, also housed in the box-shaped frame 2, for feeding a flavoring syrup. It should be noticed that FIG. 1 illustrates by way of example and therefore without limiting the scope of the invention two feed circuits 20 for respective syrups intended to give the ice cream or ice cream shake made a specific flavor. However, there may be any number of syrup feed circuits 20, depending on the variety of flavors to be given to the products dispensed by the machine 1. Each syrup feed circuit 20 has a respective infeed end 20a connected to a tank 21 for containing the syrup and an outfeed end 20b connected to the mixing chamber 6. The circuit 20 also comprises a syrup feed pump 22 for supplying the syrup to the mixing chamber 6 after a respective command, as described in more detail below.] The machine 1 also comprises means 23 for selecting the type of product, which can be switched between an ice cream dispensing condition and an ice cream shake dispensing condition.

A retrofitting attachment can be provided to effect the completed system of the present technology. An existing chilled or frozen edible food dispenser (especially with flowable, semi-liquid, pasty, gelled or frozen materials) is provided. The prior art dispenser is then evaluated to determine where components, subcomponents or parts are most likely to be adversely affected or most likely to fail or deteriorate over time. Once the nature and effects of the failure (e.g., increased power usage at a particular location, excessive vibration, excessive time usage to effect standard result, color variation in product, overheating of part, component or subcomponent, and the like as herein described), a sensor is selected that can provide signals indicative of the particularly identified result of failure or deterioration. That sensor (or multiple sensors) is provided in a kit or add-on system comprising a power source (e.g., even a link into the existing dispenser's power source, a power cord to an outlet or a battery), a housing, and a communication link to a local or distal processing/signal analyzing element (the communication links are described herein with regard to the system with the sensor/analyzer built into the dispenser and that disclosure is equally applicable to the use of the kit or retrofit or ad-on system described herein. Access holes may be needed to be appropriately cut into a housing for the dispenser if there is not sufficient internal space available in the dispenser to accept the retrofit kit in its entirety. Once the components described in the originally installed system have been provided through a retrofit system, the entire method and structure of the dispenser with sensing functionality shall operate in the same manner as the originally installed system. This is also an element that is considered an invention described herein

Underlying Theory of Operation

In operation, the monitoring system monitors the operational state of the machine and records that state, preferably with a corresponding time-stamp. In this fashion, current and historic data concerning the operational parameters of the machine can be displayed for the end user, with time stamps or merely in chronological order. Often, the greater utility is with the ability to derive new data from the time history of the machine state. For instance, the amount of material dispensed can be inferred by the number of times the ‘draw’ switch is opened and the length of time it remained open. Or from a maintenance perspective, the operational condition of components such as a motor may be inferred by knowing voltages, current draw and temperature of the motor. It is this type of utility that end users desire.

This section further describes how a system operating in conjunction with a cooling dispensing apparatus for chilled edible materials can be instrumented with sensors, how the sensors may be read, how the data can be stored, how a user might interact with the system, how the system is enabled to provide a report to a remote server for data archiving and how a user might interact with the remote server.

For complete information on the state of a machine, it may be instrumented by placing various sensors selected from groups described in the following listing:
Amperage draw on all legs of compressor and beater motors whether single phase or 3 phase.
Pressure readings on high and low side of 3 refrigeration systems
Temperatures on hopper(s), food material in the hopper(s), food material in the beater section(s), water in and out, motor temps
Ambient temperature insides and outside the machine
Voltages on the main power supply
Voltages on each leg of motor supplies
Water flow rates used for cooling
   State of all switches, contactors, solenoids or other binary devices
      While this states the sensing needs of the system, many other components are required to enable the state-of-the-art monitoring system. These components will be broken down into greater detail in later sections, however the components are defined in general terms here:
      Sensors capable of monitoring aspects of the system may be defined as including one or more of:

1. Continuous gradient measurements such as temperature, pressure, amperage draw, voltage levels, water flow.

2. Binary (two-state) measurements of the state of any switches, solenoids, contactors or other similar binary devices.

3. Transformation of sensor data into binary data accomplished by:
Current to voltage conversion using CTs
Voltage to logic level voltage conversion using VTs
Logic level voltage to binary representation conversion by ADC
State to binary conversion by conversion to appropriate voltage level and direct IO

3. Processing capability that can:
Control sensor output conversion into binary data
Record the binary data with a time stamp
Provide external communication channel capability
Provide CGI capability
Provide IO capability for control of peripherals
Provide local user interface capability
Can be directed by user interface via LCD touch screen, buttons, LED display, etc
Can be directed by user interface via communication channel (i.e. Serial, ethernet, Zigbee, etc)
Can take the form of a stand alone application communicating serially
Can take the form of web pages generated and served by the processing capability

4, Data storage capability local data storage of at least one month of data remote data storage in a communication enabled system

5. Remote data storage capability connectivity via communication channels to remote server for data storage

6. Remote data access capability
The remote capabilities can be enabled by using remote transmission capabilities known in the art, the invention using the locally provided sensors and transmission and logic devices to provide the originating information for the system and its practice.

### Sensing and Conversion to Binary Data

### Amperage:

Amperage sensing is primarily used to determine motor current draw. Amperage is sensed by placed a current transformer (CT) on each leg (line) of the electrical feed the motor. The current transformer generates a secondary AC current proportional to the current flowing through the line. That current is transformed to an AC voltage by placing a burden resistor across the output of the CT. The AC voltage is rectified, filtered and then the voltage is then inputted to an ADC for binary conversion. The resistance is selected so that the generated voltage falls within an accepted range for the logic level electronics of the ADC.

### Voltage:

Voltage sensing is used to determine correct supply on main and internal circuitry. Voltage is sensed by using a potential transformer with approximately 24:1 turns ratio such that an input of 240 VAC (RMS) is stepped down to 10 VAC (RMS). The voltage is rectified and filtered with an expected output voltage in DC not exceeding 15 VDC. The DC voltage is inputted to the ADC for binary conversion. Since the voltage when converted to DC is a reflection of peak-to-peak voltage, not RMS, the circuit may incorporate and RMS-DC convertor IC to better reflect RMS voltages (not peak-to-peak).

### Pressure:

Pressure sensing is used to determine the efficiency of the refrigeration circuits. Several technologies are available with voltage or current outputs suitable for ADC conversion to binary data.

### Temperature:

Temperature sensing is used to assist in maintaining FDA health guidelines for food storage, determine the consistency of the mix and to determine operational characteristics of the machine and refrigeration components. Temperature sensing is typically accomplished with thermo-resistive components that change resistance with temperature. The output of such a sensor is designed to be suitable for ADC conversion to binary data.

### Water Flow:

Water flow (or any liquid flow) can be sensed using a device consisting of a rotor and Hall effect sensor. As the water flows, the rotor moves faster or slower. A magnet attached to the rotor is detected by the Hall effect sensor and speed of flow is determined by the number of times the sensor is pulsed in a set time increment. The output of the device is selected to work at a logic level compatible with the monitoring system and a quadrature counter used to decode speed.

### Switch State:

Switch state may be determined by converting the switch output to a voltage level acceptable to the monitoring system logic level and used as direct IO to the system.

### Processing Capability

The system with its supporting hardware may comprise a multifunction device in the system. The processor selected for prototype development may be incorporated on a stand-alone module that includes RAM memory for running a program, Flash memory for storing a program, real-time clock for time-stamping, 10/100Base-T Ethernet and serial ports for communications (alternatively Wi-Fi and USB support as well), IO capability with multiple channels for discrete measurements and/or external communications, ADC capability for continuous voltage measurement and supporting up to 2 GB microSD memory cards for data storage.

With onboard Ethernet, the module also can perform as a web server with appropriate software. This capability will enable easy operation as a Thin Client server.

The processor runs pre-compiled machine code that has been written, tested and developed prior to operation of the device. The machine code is loaded into Flash memory on the module and runs at power on. At run-time, a self check is performed, all IO systems for sensors and control are initialized, communications capability is established such as determining its TCP/IP address and initializing a TCP stack, any error conditions are examined and may generate an alarm, the processor enters into a Finite State Machine (FSM) and is ready to respond to changes in IO parameters and/or communication requests.

At predetermined intervals, continuously and/or by interrupt, the processor reads data from all the sensors, time-stamps the data and stores it in non-volatile memory. In the event the system is a complete control system as well as a monitoring system, the processor may make decisions about controlling various systems within the machine such as fans, motors, solenoids, etc. The processor implements those decisions via IO lines.

If the system is only monitoring, the processor continues recording data at the predetermined intervals. If a user connects to the processor module by one of the enable communications modules and requests a web page, the processor generates a web page and serves it. The processor module has the capability of serving a broad variety of web pages and can include graphics such as JPG, PNG and PDF files in a served web page.

If the monitoring system also operates as a client for a remote data storage capability, it also attempts to establish communications with the remote data storage device via TCP/IP. In this event, it transfers its store of current and historic data to the remote server for archiving.

A remote archiving server might work by storing and analyzing signal information on a remote site, reducing the need for local processing capability. Notice or signaling of deficiencies may be relayed back to the local system. The information concerning the operation of such a server is capable of being developed by routine experimentation once the concept and structure of the local sensing devices has been provided.

### Local User Interface

The system may be provided along with standard commercial interface systems, such as laptops, iPads, Notebooks, and even iPhones, PADs and other commercially available user input systems in communication connection with the underlying systems of the present technology.

### Specification

A. Sensing
1. Current sensing at 240 VAC, 2-12 amps with 25 amp maximum accuracy to 0.1 amp.
   a. current transformer
   b. CR Magnetics CR8400 series or similar
   c. burden resistors
      1. commercial grade, 2%, wattage and resistance to be determined
2. Voltage sensing up to 250 VAC with accuracy of 1 VAC.
   a. transformer
   b. RMS-DC
      1. Analog Devices AD736 or equivalent
3. Pressure sensing
   a. Pressure sensitive plates and semiconductors can be provided with the electrical signals conveyed to the logic sensor analyzer.
4. Temperature sensing preferably within ±1 degree F. Thermocouples, or any other commercially available format or component to provide electrical signals relating to the temperature can be provided for at least the following elements of the system.
   a. hopper
   b. beater
   c. motor
   d. water temp
   e. cabinet ambient
   f. external ambient
5. Flow sensing
   a. SeeedStudio model G1/2 or equivalent

B. Data conversion 8 or 12 bit resolution
1. ADC
   a. ADC0838 IC or equivalent

C. Processing MIPS unknown at this time
1. Rabbit Semiconductor RCM-4300 module

D. User interface
1. LCD
2. Key pad
3. Touch Screen
4. Voice recognition input
5. Browser
   a. Firefox preferred

E. Local data storage up to 2 GB non-volatile storage.

F. Remote data storage

G. Remote user interface

Alternative Descriptions of Elements of Practice within the General Scope of Practice

The following information is a capsulated listing of concepts that may be further considered in the practice of the present technology, without further limiting the scope of the claims or disclosure.

The described system, apparatus and method is used for data-acquisition and analysis of time-variant operational parameters of mechatronic frozen food (frozen dessert, etc) machines. The apparatus with processing means may or may not run software, reconfigurable circuitry configurations (etc.) to enable data to be acquired and communications to be established via Ethernet, Wi-Fi, Zigbee, Serial, USB, etc., as well as by local capture and independent reporting. The apparatus may provide current sensing means (transformers) connected to the processing means to allow current measurement. The voltage sensing means may be connected to the processing means to allow voltage sensing measurement. The temperature sensing means may be connected to the processing means to allow voltage sensing measurement. Quantity measurement means may also be connected to the information collection, transmission and storage systems, as would flow rate measurement components, switch positions that may be measured.

One method enables retrofitting an existing frozen desert device with the preceding apparatus enabling the measurement of currents, voltages, temperatures, product quantity, flow rates, and switch positions. Time-keeping components that provide that measurements can be associated with a timestamp are preferred. There should be logic conversion components such that the measurements from sensors 2-9 can be converted to digital data. Data logging components such that the values sensed by sensors of 2-9, converted to digital data, can be recorded in volatile memory, preferably with an associated timestamp. Non-volatile memory storage systems may be provided such that the values sensed by sensors of 2-9, converted to digital data, can be recorded in non-volatile memory with an associated timestamp. There may be direct user interfaces for viewing current and/or historic data that may be but not limited to LCD panels, vacuum florescent display, other indicators. The system should include direct user interface means for interacting with the apparatus that may be but not limited to mechanical buttons, switches, capacitance sensors, membrane switches, with the system and method for presentation of data from above definition to an end user located locally or distally via Ethernet, Wi-Fi, Zigbee, Serial, USB communications.

Further technology and practices included within the scope of the present invention may be generally described as directly reading and time stamping binary state data on switches, contactors, solenoids, etc. The current ‘state’ of the machine and individual components is sensed, date stamped and derived. We can actually write a Finite State Machine algorithm for how the device should operate, and what individual components should be on and off at various times. This analysis and derived information enables derivation of useful operator/maintenance/owner/etc information, such as time in use, volumes dispensed, error conditions, etc The time dispensing (might also call The Draw because there is a draw switch than can be monitored) may be very important in a lessee/lessor relationship. It is different than the amount of product dispensed.

Therefore the system may be capable of
1. directly read information
   1. state of binary sensors in the machine
2. providing derived information:
   1. The amount of time the machine or individual components are in use
   2. The amount of time the system is actually dispensing material
   3. Volume dispensed
   4. MTBF (mean time between failures) on maintenance items
   5. the user interacting with the monitoring and control system to modify parameters as needed during variations in use/3.
3. A thin client interface for a user interacts with the monitoring and control system directly via Ethernet, Wi-Fi, USB, etc.
4. The processing presents a user interface that displays real time operational parameters of the machine.
5. The processing presents a user interface displays historical data concerning the operational parameters of the machine.
   6. The user interface presents real-time derived data.
   7. The user interface presents historical derived data.
   8. Using the processing to generate a user interface by CGI or other types of user interfaces such as LCD screen, serial I/O, etc.
   9. Using the processing to generate real-time and/or historic data in a document format such as PDF, PNG, JPEG, etc.
   10. New peripherals may be attached to the machine.
   11. The monitoring and control system may control the new peripherals attached to the machine.
   12. The monitoring and control system may supersede current control systems on a retrofitted machine.
   13. The monitoring and control system may contact a remote server (via whatever comm channel).
   14. The monitoring and control system may contact a remote server to transmit historical data for archiving.
15. The monitoring and control system may download new software from the remote server
16. The users may contact and direct the remote server.
17. The users may contact the remote server and request current and/or historic data, direct or derived about a specific machine and/or site.
18. The users may contact the remote server and request current and/or historic data, direct or derived about a group of machines.
19. The remote server would generate CGI web pages that show real-time and/or historic direct and derived data to send to a user.
20. The data resident on the monitoring and control system might be used for billing purposes (for instance in a lessee/lessor relationship), with invoices directly and automatically sent by electronic messaging.
21. The data resident on a remote server might be used for billing purposes.

Although specific values, materials, components and subcomponents have been identified as useful in the practice of the present technology, those descriptions should not be interpreted as limiting the generic scope of the invention as claimed. Variations within the skill of the ordinary artisan may be used to enhance or optimize performance, yet remain within the scope of the technology disclosed and claimed herein.

What is claimed:

1. A dispensing system for a chilled viscous edible composition, the dispensing system comprising:
a storage container for the viscous edible composition;
a composition moving system;
a composition chilling system;
a cooling system;
an electromechanical system control components for assisting in composition moving;
an electrical input system for providing power to the composition moving system(s), chilling system(s), cooling system and system control component;
an electrical communication network among the electrical input system and the composition moving system(s) chilling system, cooling system and system control component;
a sensor for detecting at least one performance attribute that occurs during movement of the composition by the composition moving system;
a sensor for detecting at least one performance attribute that occurs during chilling of the composition by the chilling system;
a sensor for detecting at least one performance attribute that occurs during cooling of the system by the cooling system;
a sensor for detecting at least one performance attribute that occurs during control of the system by the control system;
the sensors providing signals to electronic hardware;
the electronic hardware registering sensor signals with a time stamp;
the electronic hardware configured to perform data analysis on the time-stamped signals derive to detecting and recording specified undesirable performance of the dispensing system.

2. The dispensing system of claim 1 wherein the electronic hardware configured to perform data analysis on the time-stamped signals derive to detecting and recording specified undesirable performance of a chilling system.

3. The dispensing system of claim 1 wherein the electronic hardware configured to perform data analysis on the time-stamped signals derive to detecting and recording specified undesirable performance of a cooling system.

4. The dispensing system of claim 1 wherein the sensor provides a signal with respect to energy usage rate of the composition moving system and the energy usage rate is derived from the signal for evaluation of performance of that energy usage rate.

5. The dispensing system of claim 1 wherein the sensor detects vibrations in the composition moving system.

6. The dispensing system of claim 1 wherein voltage sensors and/or current sensors, or derived evaluations of signals communicate through wireless transmission to a logic system and/or memory storage have been retrofit into the dispensing system previously lacking voltage sensors and/or current sensors communicating through wireless transmission to a logic system and/or memory storage.

7. A method of identifying levels of performance in the edible chilled food dispensing system of claim 1 comprising:
a) chilling and cooling edible dispensable compositions.
b) moving the dispensable compositions within the system;
c) sensing at least one performance attribute of the dispensing system;
d) sending a signal of the at least one performance attribute to a logic analyzer;
e) the logic analyzer determining a quality indication from the signal of the at least one performance attribute;
f) providing an indication to a user of the edible food dispensing system of a predetermined level of insufficient performance in the at least one performance attribute.

8. The method of claim 7 wherein the electronic hardware performs data analysis on a time-stamped signal to detect and record specified undesirable performance of a chilling system.

9. The method of claim 7 wherein the electronic hardware performs data analysis on a time-stamped signal to detect and record specified undesirable performance of a cooling system.

10. The method of claim 7 wherein at least one sensor detects energy usage rate of the composition moving system.

11. The method of claim 7 wherein the sensor detects vibrations in the composition moving system.

12. The method of claim 7 wherein in a dispensing system previously lacking voltage sensors and/or current sensors or derived evaluations of sensed signals are communicate through wireless transmission to a logic system and/or memory storage, voltage sensors and/or current sensors communicating through wireless transmission to a logic system and/or memory storage are retrofit into the dispensing system so as to transmit electric hardware performance data to a logic system.

13. A process of chilling, thickening and dispensing chilled edible materials comprising:
chilling, stifling and temporarily storing edible materials within a system;
dispensing chilled edible materials;
a sensor sensing power usage within the system at least one power usage component within the system;
sending signals from the sensor to a logic device;
identifying a status or change in at least one parameter selected from the group consisting of power usage, parts speed, resistance, flow rate, binary switching state by the at least one power usage component;
corelating identified status or change in the at least one parameter to operational or performance of the system; and
identifying a deficiency in the operation and/or performance of the system by outputting a signal identifying the deficiency

14. The process of claim 13 wherein a sensor directly reads and time stamping binary state data on at least one components selected from the group consisting of switches, contactors and solenoids

15. The dispensing system of claim 1 wherein the sensor identifies a state of binary switching in at least one component of the system.

16. The dispensing system of claim 1 wherein the dispensing system has at least one component selected from the group consisting of:
a) a processor or other hardware that directly reads information provided from at least one sensor;
b) an electronic element that provides information derived from information read from at least one sensor to a second processor, the provided information selected from the group consisting of
1. a total amount of time the system or individual components of the system have been in use;
2. an amount of total time the system has been actually dispensing material;
3. a total and/or individual volume of chilled edible material dispensed;
4. mean time between failures on individual components or routine maintenance procedures;
5. a user interface enabling user input to a monitoring system or control system for the dispensing system, the user interface allowing modification of operation parameters in response to information provided as information of b)1), b)2), b)3) and/or b)4);
c) a thin client interface enabling distal user interaction to a monitoring system or control system for the dispensing system via at least one communication network comprising Ethernet, Wi-Fi, USB, or hardwire connection;
d) the processor in communication with a user interface to present image data to present derived information enabling visual display of real time operational parameters of the machine or historical data of operational parameters of the dispensing system and/or components thereof.
e) the processor configured to generate a user interface;
f) the processor configured to generate real-time and/or historic data in a document format;
g) an operation monitoring and operation control system configured to control peripherals directly attached to the dispensing system;
h) an operation monitoring and operation control system retrofitted on a dispensing system having an overridable second control system original to the retrofitted dispensing system;
i) an operation monitoring and operation control system configured to communicate with a remote server via an external communication channel;
j) the monitoring and control system of i) configured to accept download of software from the remote server;
k) a user interface associated at a site with the dispensing system configured to communicate with a remote server to request current and/or historic data, direct or derived about a specific machine and/or site;
l) a remote server in information communication with a processor for a dispensing system at a site where the dispensing system is present, the remote server configured to generate CGI web pages that show real-time and/or historic direct and derived data to a user;
